(19) United States
(12) Patent Application Publication
(10) Pub. No.: US 2023/0173437 A1
(43) Pub. Date: Jun. 8, 2023

(54) SEPARATIONS MEMBRANE AND METHOD OF MAKING THE SAME

(71) Applicant: Purdue Research Foundation, West Lafayette, IN (US)

(72) Inventors: John Alan Howarter, West Lafayette, IN (US); Michael D. Toomey, West Lafayette, IN (US); Logan Kearney, Long Grove, IL (US)

(73) Assignee: Purdue Research Foundation, West Lafayette, IN (US)

(21) Appl. No.: 18/075,144

(22) Filed: Dec. 5, 2022

Related U.S. Application Data
(60) Provisional application No. 63/286,369, filed on Dec. 6, 2021.

(51) Int. Cl. B01D 71/82; B01D 71/56; B01D 71/68; B01D 69/10; B01D 69/12; B01D 69/02; B01D 67/00; B01D 61/02

(52) U.S. Cl. CPC B01D 71/82; B01D 71/56; B01D 71/68; B01D 69/1071; B01D 69/1216; B01D 69/02; B01D 67/0006; B01D 67/0095; B01D 69/1251; B01D 61/025; B01D 2325/04; B01D 2325/30; B01D 2323/40; B01D 2323/219; B01D 2323/36

(57) ABSTRACT

The separations membrane system includes a substrate, a microporous layer, and a selective layer. The microporous layer may be disposed over the substrate. The selective layer may be disposed over the microporous layer, thereby sandwiching the microporous layer between the selective layer and the substrate. The microporous layer includes a thermoplastic material. The selective layer includes a polyamide structure of 2,2-Dimethyl-1,3-propanediamine and/or 1,3,5-Benzenetricarbonyl chloride.

### CROSS REFERENCE TO RELATED APPLICATIONS

This application claims the benefit of U.S. Provisional Application Ser. No. 63/286,369, filed on Dec. 6, 2021. The entire disclosure of the above application is hereby incorporated herein by reference.

### GOVERNMENT RIGHTS

This invention was made with government support under DMR1838513 and CBET1605882 awarded by the National Science Foundation. The government has certain rights in the invention.

### FIELD

The present disclosure relates to membranes and, more particularly, to reverse osmosis membranes.

### INTRODUCTION

This section provides background information related to the present disclosure which is not necessarily prior art.

Reverse osmosis membrane water separation is an essential technology necessary in providing today's water demands. Biofilm accumulation due to the presence of microorganisms in the feedwater limits the performance of these essential water separation membranes by reducing flux and rejection performance. To militate against the occurrence of biofouling, mitigation strategies are commonly employed to inactivate the microorganisms, preventing their adsorption. One of the most common known mitigation strategies is the dosing of free chlorine into the feedwater. While effective, free chlorine species have been shown to degrade the polyamide selective layer used in RO membranes.

Research has shown that the interaction with free chlorine results in both irreversible ring chlorination and reversible N-chlorination of the amidic N. The absolute reversibility of the N-chlorination reaction has been disputed, where some studies indicate that chain scission may result under some conditions. Despite this dispute, there is a consistent reporting of correlations between ring chlorination events and performance (i.e. salt rejection and flux) decline. In order to ensure the long-term operability of reverse osmosis membranes without risk of performance decline due to free chlorine exposure new strategies are being explored.

A few known strategies explored focus on the elimination of the need for free chlorine by increasing the surface hydrophilicity of the membrane, disincentivizing foulant adsorption. Undesirably, these approaches often result in significant flux declines. Alternatively, different disinfectants have been explored in efforts to eliminate free chlorine, though most current research suggests that this results in either lessened effectiveness of microorganism inactivation, the formation of harmful byproducts, high operating costs, and the degradation of the PA membrane structure/performance.

Recent research has implemented various strategies in efforts to create a chlorine tolerant membrane. Known methods synthesized reverse osmosis membranes out of graphene-oxide loaded polyimide, resulting in moderate increases in flux and rejection performance which showed little performance loss after 1000 ppm*h exposure to free chlorine under circumneutral conditions. However, extreme chlorine tolerance was not tested. A standard interfacially polymerized membrane can maintain or improve rejection and flux performance up to several thousand ppm*h without much change in performance, so further chlorination studies should be conducted to probe its long-term chlorine resistance. Known systems report the synthesis of a highly chlorine resistant membrane capable of rejections comparable of that of standard network aromatic PA membranes, while maintaining performance up to 100,000 ppm*h free chlorine exposure. While this certainly is a significant step toward achieving a fully chlorine resistant membrane, it is a labor-intensive approach, which employs multiple interfacial polymerization reactions occurring in succession. This complex manufacturing process may hinder the ability to rapidly produce the membranes at scale and require large (double or triple) the volume of organic solvent in making a single standard membrane.

There is a continuing need for a separations membrane system and method that militates against irreversible chlorination from occurring, thereby also militating against long-term performance decline in RO membranes. Desirably, the separations membrane system and method may be more efficiently manufactured compared to known chlorine tolerant membrane synthesis methods.

### SUMMARY

In concordance with the instant disclosure, an efficient separations membrane system and method which enhance the mass uptake of free oxidants, has been surprisingly discovered. Desirably, the separations membrane system may enable long-term efficacy of reverse osmosis (RO) water separation operations.

The separations membrane system includes a substrate, a microporous layer, and a selective layer. The microporous may be disposed over the substrate. The selective layer may be disposed over the microporous layer, thereby sandwiching the microporous layer between the selective layer and the substrate. In a specific example, the substrate may include a non-woven polyester material. In another specific example, the microporous layer may include a polysulfone material. The selective layer may include a polyamide structure of 2,2-Dimethyl-1,3-propanediamine. In certain circumstances, the polyamide structure may also include 1,3,5-Benzenetricarbonyl chloride.

In another embodiment, the present technology includes methods of manufacturing a separations membrane system. For instance, a method of manufacturing the separations membrane system may include synthesizing a microporous layer on a substrate. The substrate may include a non-woven polyester material. Next, a selective layer may be synthesized over the microporous layer, thus forming a separations membrane. The selective layer may include a polyamide structure of 2,2-Dimethyl-1,3-propanediamine. In a specific example, the polyamide structure of the selective layer may also include 1,3,5-Benzenetricarbonyl chloride. Afterwards, the separations membrane may be cured. For instance, the separations membrane may be heated to around eighty degrees Celsius for curing.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic front elevational view of a separations membrane system including a substrate, a microporous layer, and a selective layer, according to one embodiment of the present disclosure;

FIG. 2 is a top perspective view of the separations membrane system including a substrate, a microporous layer, and a selective layer, according to one embodiment of the present disclosure;

FIG. 3 is a box diagram illustrating a deposition cycle for preparing the separations membrane system membranes, according to one embodiment of the present disclosure;

FIG. 4 is a line graph illustrating the mass uptake of known membranes exposed to 500 ppm free chlorine, according to one embodiment of the present disclosure;

FIG. 5 is a line graph illustrating the mass uptake rate of known membranes exposed to 500 ppm free chlorine, according to one embodiment of the present disclosure;

FIG. 6 is a line graph illustrating the mass uptake of the separations membrane system after repeated chlorine exposures, according to one embodiment of the present disclosure;

FIG. 7 is a line graph illustrating the mass uptake rate of the separations membrane system after repeated chlorine exposures, according to one embodiment of the present disclosure;

FIG. 8 is a line graph illustrating the mass loss of the separations membrane system after repeated chlorine exposures, according to one embodiment of the present disclosure;

FIG. 9 is a plot diagram illustrating a comparison of rejection percentage with increasing levels of free chlorine exposure between known membranes and the separations membrane system (DMDAP Membrane), further depicting the long-term maintenance of rejection performance of the separations membrane over the known membrane, according to one embodiment of the present disclosure;

FIG. 10 is a plot diagram illustrating a comparison of relative rejection performance with increasing levels of free chlorine exposure between known membranes and the separations membrane system, further depicting the long-term maintenance of rejection performance of the separations membrane over the known membrane, according to one embodiment of the present disclosure;

FIG. 11 is a plot diagram illustrating a comparison of flux with increasing levels of free chlorine exposure between known membranes and the separations membrane system, according to one embodiment of the present disclosure;

FIG. 12 is a plot diagram illustrating a comparison of relative flux with increasing levels of free chlorine exposure between known membranes and the separations membrane system, according to one embodiment of the present disclosure;

FIG. 13 is a flow chart illustrating a method of manufacturing the separations membrane system, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature unless otherwise disclosed, and thus, the order of the steps can be different in various embodiments, including where certain steps can be simultaneously performed.

### I. Definitions

Unless otherwise defined, all technical terms used herein have the same meaning as commonly understood by one of ordinary skill in the art to which the present disclosure pertains.

As used herein, the terms “a” and “an” indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. In the present disclosure the terms “about” and “around” may allow for a degree of variability in a value or range, for example, within 10%, within 5%, or within 1% of a stated value or of a stated limit of a range. Likewise, in the present disclosure the term “substantially” can allow for a degree of variability in a value or range, for example, within 90%, within 95%, or within 99% of a stated value or of a stated limit of a range.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### II. Description

Lacking from known chlorine resistance studies is the use of ultrathin barrier layers for their ability to slow the diffusion of free chlorine species. While this approach might also have the impacts of reducing flux, the ultrathin nature (<10 nm) of such a modification may limit the effect of flux decline by reducing the diffusion distance water must pass through before reaching the standard membrane chemistry. Conversely, single halogenated aniline endcapping results in significant flux increases, however more rapid performance decline occurs in the presence of free chlorine. This is attributed to the lack of ability of the halogenated anilines have to participate in building a network atop the standard interfacially polymerized membrane, leaving significant amounts of polyamide structure exposed to intruding free oxidant molecules during chlorination. Advantageously, the formation of a pre-chlorinated ultrathin network structure may act as a better system for free chlorine diffusion, while having limited effects on flux.

Methods which employ single interfacial polymerization approaches to synthesize new membrane chemistries enable rapid deployment of chlorine tolerant membranes without large capital costs to membrane manufacturers. Given the irreversible nature of chlorine uptake at the amide-N, polyamide structures lacking these aromatic functionalities are desirable. This requires the replacement of the common monomer m-phenylene diamine (MPD) with an alternative diamine. For instance, 2,2-dimethyl-1,3-diaminopropane (DMDAP) may have similar structural characteristics, given that the methyl functionalities would provide some steric separation within the polyamide (PA) structure, potentially promoting a small increase in free volume to promote water diffusion.

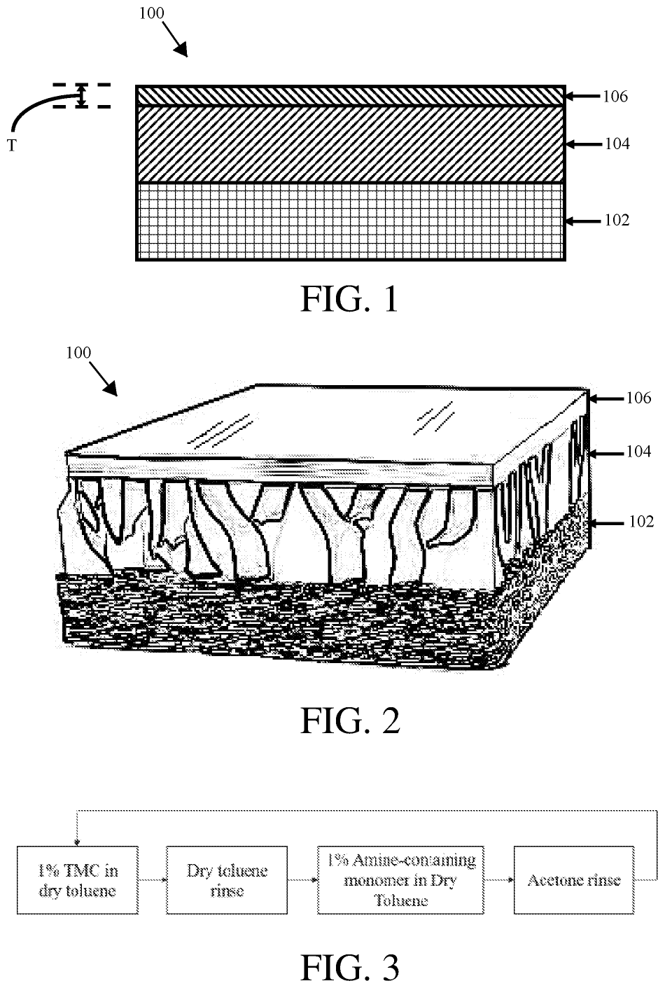

As shown in FIGS. 1-2, the separations membrane system 100 includes a substrate 102, a microporous layer 104, and a selective layer 106. The microporous layer 104 may be disposed over the substrate 102. The selective layer 106 may be disposed over the microporous layer 104, thereby sandwiching the microporous layer 104 between the selective layer 106 and the substrate 102. In a specific example, the substrate 102 may include a non-woven polyester material. In another specific example, the microporous layer 104 may include a thermoplastic material. For instance, the thermoplastic material may include polysulfone. In a more specific example, the thermoplastic material may be nanoporous. The selective layer 106 may include a diamine characterized by without having an aromatic ring structure. In another specific example, the diamine characterized by without having an aromatic ring structure may include a polyamide structure of 2,2-Dimethyl-1,3-propanediamine. In certain circumstances, the polyamide structure may also include a chloride containing material. In a specific example, the chloride containing material may include 1,3,5-Benzenetricarbonyl chloride and/or trimesoyl chloride. In a specific example, the selective layer 106 may have a thickness T less than around fifty nanometers. In a more specific example, the selective layer may have a thickness T of around ten nanometers or less. One skilled in the art may select other suitable materials or dimensions to form the selective layer 106, within the scope of one skilled in the art.

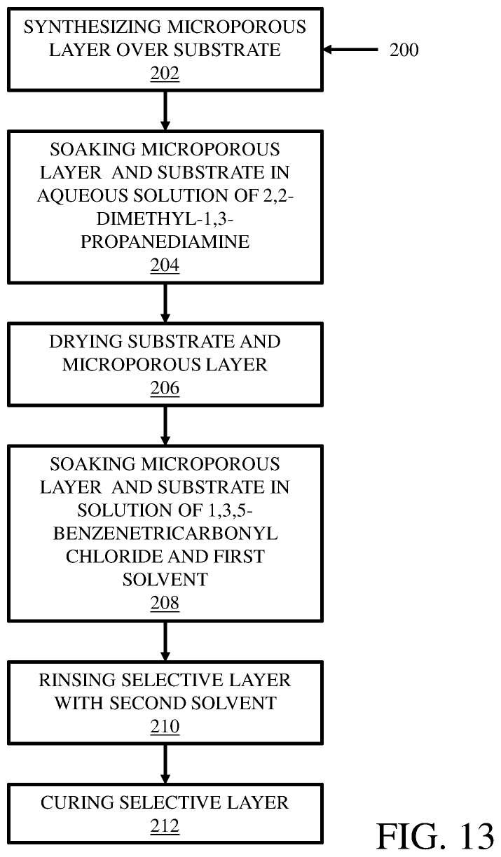

In another embodiment, the present technology includes methods of manufacturing a separations membrane system 100. For instance, as shown in FIG. 13, a method 200 of manufacturing the separations membrane system 100 may include synthesizing a microporous layer 104 on a substrate 102. The substrate 102 may include a non-woven polyester material. Next, a selective layer 106 may be synthesized over the microporous layer 104. The selective layer 106 may include a diamine characterized by without having an aromatic ring structure. The diamine characterized by without having an aromatic ring structure may include a polyamide structure of 2,2-Dimethyl-1,3-propanediamine. In a specific example, the polyamide structure of the selective layer 106 may also include a chloride containing material. In a more specific example, the chloride containing material may include 1,3,5-Benzenetricarbonyl chloride and/or trimesoyl chloride. Afterwards, the separations membrane system 100 may be cured. For instance, the separations membrane system 100 may be heated to around eighty degrees Celsius for curing.

With continued reference to FIG. 13, in certain circumstances, the step 204-210 of synthesizing the selective layer 106 over the microporous layer 104 may further include soaking the substrate 102 and the microporous layer 104 in isopropyl alcohol. Next, the substrate 102 and the microporous layer 104 may be soaked in deionized water. In a specific example, the substrate 102 and the microporous layer 104 may be soaked in isopropyl alcohol and/or water until substantially all surface contaminants are removed. For instance, the substrate 102 and the microporous layer 104 may be soaked in isopropyl alcohol and/or water for more than around eight hours. Afterwards, the microporous layer 104 may be soaked in an aqueous solution of 2,2-Dimethyl-1,3-propanediamine. The 2,2-Dimethyl-1,3-propanediamine may deposit into a portion of the pores of the microporous layer 104. Then, the substrate 102 and the microporous layer 104 may be dried to remove excess 2,2-Dimethyl-1,3-propanediamine. Next, the microporous layer 104 deposited with the 2,2-Dimethyl-1,3-propanediamine may be soaked in a solution of 1,3,5-Benzenetricarbonyl chloride and a first solvent, thereby forming the selective layer 106. The first solvent may be configured to dissolve the 2,2-Dimethyl-1,3-propanediamine and/or the 1,3,5-Benzenetricarbonyl chloride. In a specific example, the first solvent may have a lower density than water. In a more specific example, the first solvent may include a hexane solvent, a pentane solvent, a heptane solvent, a decane solvent, a dodecane solvent, and/or a nonane solvent. Afterwards, the selective layer 106 may be rinsed with a second solvent. It is contemplated that the second solvent to be the same as the first solvent. Alternatively, in certain circumstances, the second solvent may be different from the first solvent. The second solvent may be configured to dissolve the 2,2-Dimethyl-1,3-propanediamine and/or the 1,3,5-Benzenetricarbonyl chloride. In a specific example, the second solvent may have a lower density than water. In a more specific example, the second solvent may include a hexane solvent, a pentane solvent, a heptane solvent, a decane solvent, a dodecane solvent, and/or a nonane solvent. One skilled in the art may select other suitable processes and materials to synthesize the selective layer 106, within the scope of the present disclosure.

### III. Example

Provided as a specific, non-limiting example, a quartz crystal microbalance (QCM) was used to probe the rates of mass uptake within model membranes of a standard network aromatic PA with varying degree of halogenated aromatic endcaps (0, 1, 5, and 10 bilayer), and in the separations membrane system 100 synthesized from the reaction of trimesoyl chloride (TMC) and DMDAP. This non-limiting example is provided to show that the separations membrane system 100 having DMDAP containing membranes may successfully militate against irreversible chlorination from occurring, thereby also militating against long-term performance decline in RO membranes.

Prior to QCM analysis, model membranes were deposited by the following method. QCM sensors were first treated in a UV-ozone chamber, commercially available from BioForce Nanosciences, inc., for ten minutes to remove any surface contaminants prior to mLbL deposition. FIG. 3 illustrates the standard deposition cycle. The number of deposition cycles and the amine-monomer chemistries used for each sample are detailed in Table 1, as shown below. With exception to the DMDAP membrane, all membranes were comprised of fifteen bilayers of the standard network aromatic polyamide chemistry in addition to the added bilayers for endcapping. The DMDAP model membrane was limited to 5 deposition cycles due to the development of heterogenic surface structures when more bilayers were added.

TABLE 1

| | | # | | # |
|---|---|---|---|---|
| | Base Layer | Deposi- | | Endcapping |
| | Amine | tion | Endcapping | Deposition |
| Sample | Chemistry | Cycles | chemistry | Cycles |
| Standard | m-phenylene | 15 | — | 0 |
| | diamine | | | |
| FlA | m-phenylene | 15 | 3,4- | 1 |
| | diamine | | Difluoroanaline | |
| ClA | m-phenylene | 15 | 4-Chloroaniline | 1 |
| | diamine | | | |
| BrA | m-phenylene | 15 | 4-Bromoanaline | 1 |
| | diamine | | | |
| 5BL- | m-phenylene | 15 | 4-Chloro m- | 5 |
| ClMPD | diamine | | phenylenediamine | |
| 10BL- | m-phenylene | 15 | 4-Chloro m- | 10 |
| ClMPD | diamine | | phenylenediamine | |
| DMDAP | 2,2-dimethyl-1,3- | 5 | — | — |
| | diaminopropane | | | |

After model membrane deposition, interaction between the membranes and free chlorine was probed using the QCM. For testing, model membrane samples were placed in the QCM cell and were first equilibrated in water. After mass equilibration in water, 500 ppm aqueous solutions of NaOCl, with pH adjusted to 7.4 using HCl was pumped into the QCM cell at a rate of 1.4 mL/min, and resonant frequency and dissipation factor changes were recorded. Voigt modelling of the recorded response for the selective layer 106 was performed using QTOOLS™ software commercially available from Biolin Scientific AB.

Interfacial polymerization of standard reverse osmosis membranes and DMDAP-containing reverse osmosis membranes 100 was performed for the crossflow characterization and chlorine resistance assessment of bulk scale membranes. Prior to synthesis, membranes were soaked overnight in isopropyl alcohol, then overnight in deionized water to remove any surface-protective layers from the polysulfone. Next, the polysulfone membranes were placed in water-tight frames to house the solutions used during the interfacial polymerization process. After placing membranes in the reaction frame, a 2 wt. % aqueous solution of either MPD or DMDAP was introduced to soak into the polysulfone substrate 102 for 10 minutes. After 10 minutes, the solution was poured off, the surface was dried using a rubber roller, and then a 0.2 wt. % solution of TMC in hexane was placed into the reaction frame for 15 minutes. After 15 minutes of reaction, the TMC solution was then poured off before subsequent rinsing with hexane and drying at 80° C. for 5 minutes. After synthesis, membrane samples were stored in deionized water prior to testing in the crossflow cell.

Chlorine tolerance of interfacially polymerized DMDAP-containing membranes was performed using a CF-042™ crossflow cell commercially available from Sterlitech Corporation. Rejection and flux performance was assessed at 800 psi operating pressure, with a 1 gpm crossflow rate, and 400 ppm NaCl feedwater concentration. Water temperatures were maintained at 28±3° C. using a Polyscience (Niles, Ill.) recirculating chiller. Rejection performance of the membranes was assessed by continually measuring the TDS of the permeate collected in 15 mL aliquots in a scintillation vial until permeate concentration plateaued. Rejection was calculated by equation 6.1, shown below, where Cperm and Cfeed are salt concentrations of the permeate and feedwater, respectively, as measured by TDS measurement.

$$R = \frac{{C}_{perm}}{{C}_{feed}} \qquad Eq . 6.1$$

After rejection plateaued, permeate was mass for thirty minutes to calculate the average flow rate, which was in-turn normalized by the membrane active area to calculate flux (L/(m²d)).

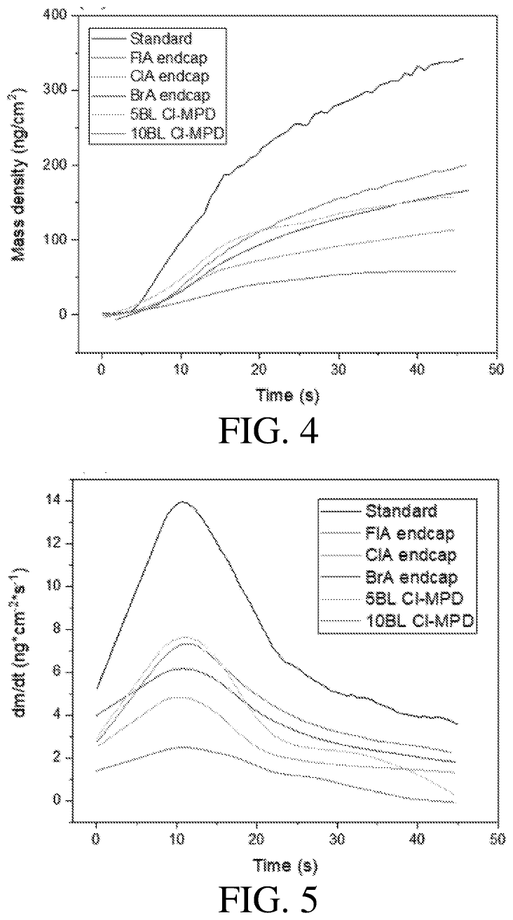

The chlorine response in the first minute of interaction with membranes functionalized using halogenated aminic monomers is shown in FIGS. 4-5. With continued reference to FIGS. 4-5, the addition of halogenated endcaps limits the rate of mass uptake into the selective layer 106. Mass uptake was such that the standard membrane showed the largest and fastest uptake rate, with samples FlA, BrA, 5BL-Cl-MPD, ClA, and 10BL-Cl-MPD, in succession, showing considerably less uptake. Uniquely, the interfacially polymerized FlA, ClA, and BrA endcapped membranes displayed increased rates of performance loss when exposed to free chlorine. Without being bound to any particular theory, this discrepancy may be explained by the differences in network structure which occur during interfacial polymerization. This would indicate that the looser structure in regions of the interfacially polymerized membrane, while still capable of being endcapped with the halogenated aniline, may offer little resistance to free chlorine diffusion, providing support for the hypothesis of dilatational effects of the endcapping unit improving back diffusion of salt and increasing accessibility to the underlying polyamide structure. The trends here, which are counter to the results of performance loss of interfacially polymerized membranes, are attributed to the highly controlled and highly crosslinked structure which is a characteristic of the mLbL process providing a tighter network for the halogenated anilines to provide resistance to the diffusion of free chlorine. Another notable feature is the effect that multiple endcapping bilayers have on the rate of mass uptake. Increasing the number of bilayers reduces the rate that chlorine is taken up by the membrane. The sample having a 5-bilayer endcap of halogenated MPD (5BL-Cl-MPD) appears to display mass uptake and uptake rates similar to that of the samples having a single halogenated aniline endcap. This may be attributed to the dendritic nature of selective layer 106 growth, before there is enough chain length/flexibility to provide the conformational changes necessary for crosslinking to occur in the membrane. Thus, the significantly slower mass uptake rate in the 10-bilayer sample (10BL-Cl-MPD) might suggest that more effective crosslinking occurs to provide more resistance to free chlorine diffusion into the unadulterated PA structure.

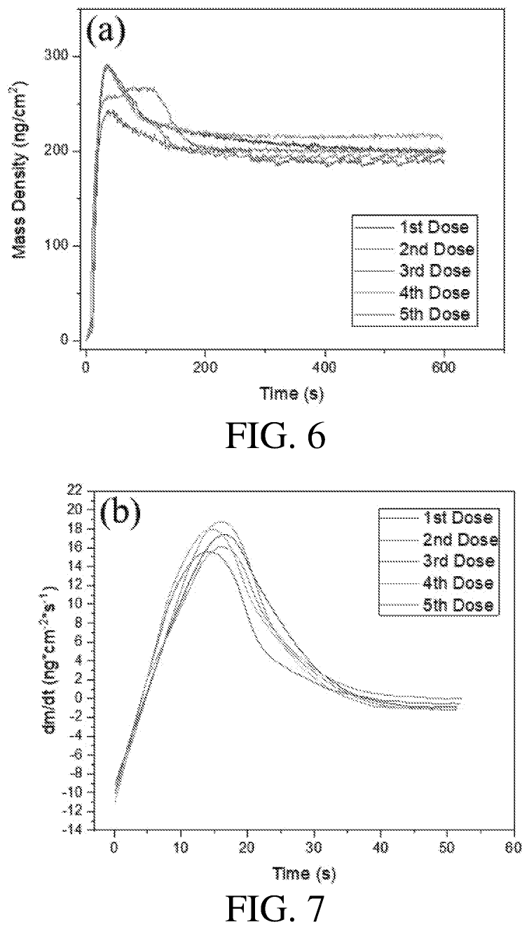

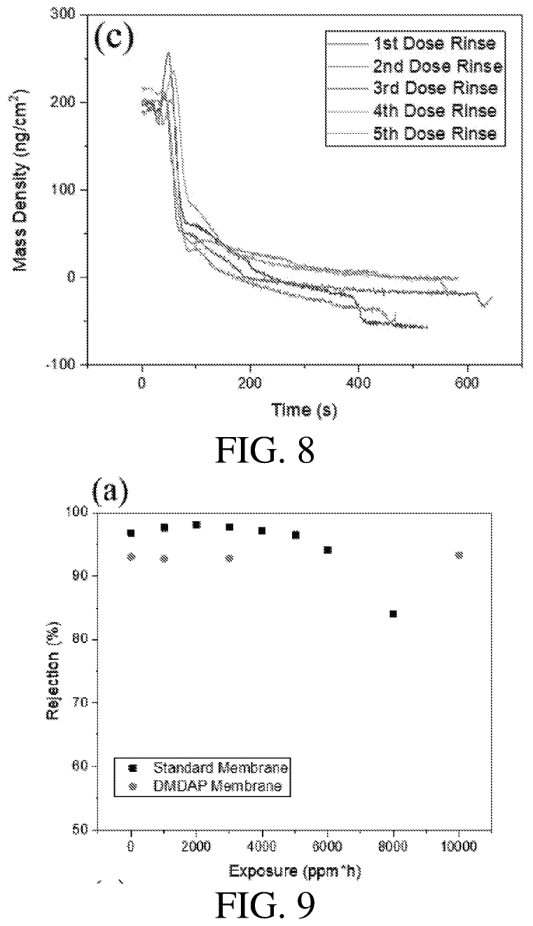

As shown in FIGS. 6-8, changes in mass uptake and uptake rate in the DMDAP model membrane as a function of free chlorine under repeat exposures were observed. Upon repeat dosing, mass uptake occurs in a repeating manner. All samples displayed mass uptake values having maximums in the range of 240-300 ng/cm² before rapidly plateauing to 200-230 ng/cm². This is in the expected range of mass uptake for N-chlorination. The repeatability shown here is counter to what has been shown to occur in standard network aromatic polyamide membranes dosed in a similar manner. The lack of repeatability of mass uptake during chlorination of standard PA is largely attributed to the irreversible chlorination occurring at the N-adjacent aromatic ring. Here, by eliminating the aromatic group, such irreversible chlorination may have been eliminated. Mass changes in the membrane once deionized water was reintroduced to the crossflow cell following 10 minutes of free chlorine exposure, as shown in FIG. 8. With exception to the first and second dose, mass loss occurs, continually returning to near the initial baseline value. This supports the reversibility of N-chlorination and provides evidence that indicates that membranes synthesized using DMDAP may provide significant chlorine resistance. The sub-zero mass values occurring in the first two doses may be attributed to the release of trapped monomer which was unable to react during the mLbL synthesis. The repeatability of mass uptake rates ranging from 16-19 ng/cm² may also be an indication that the membrane is resistant to chain scission previously reported for PA RO membranes. Scission events would reduce crosslink density, loosening the network structure. Given the solution-diffusion framework, such an occurrence would likely result in increased rates of mass uptake due to increased solubility and diffusivity of the free chlorine moieties.

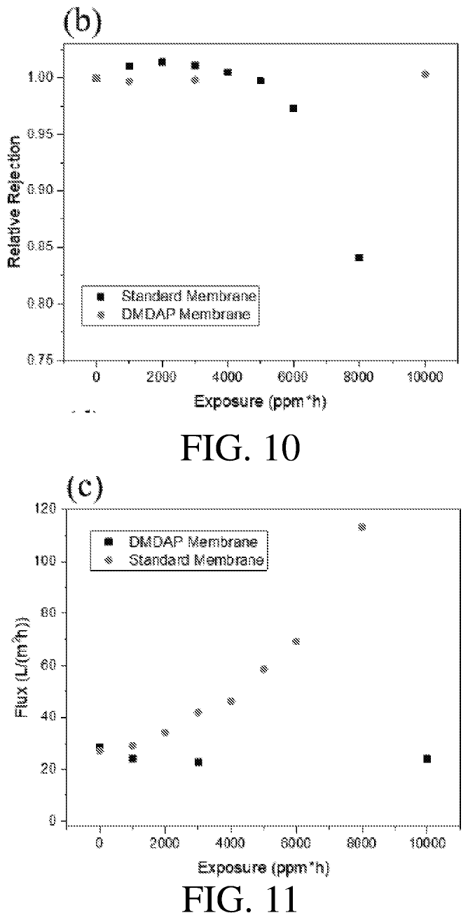

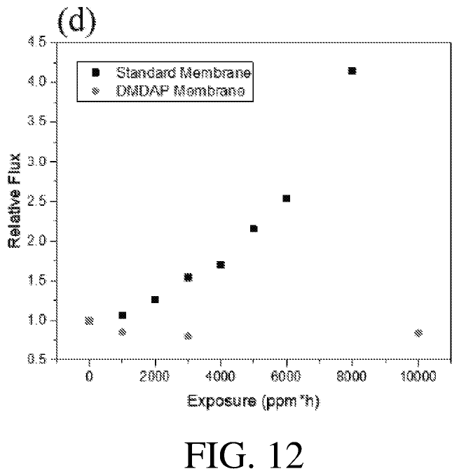

FIGS. 9-12 show preliminary flux and rejection performance for both standard and DMDAP comprised interfacially polymerized membranes. The standard membrane, having an initial rejection of 96.7%, increased to 98.1% after 2000 ppm*h free chlorine exposure. After reaching the maximum, rejection performance began decline, showing a drop to 84.0% selectivity after 8,000 ppm*h exposure. Uniquely, while the DMDAP membrane had a lower initial performance of 93.0% rejection, the salt selectivity of the DMDAP membrane was maintained, fluctuating between 92.7% and 93.3% at 10,000 ppm*h.

Both membrane chemistries displayed similar initial flux, with the standard and DMDAP membranes displaying permeate flux of 27.3 and 28.6 L/(m²h), respectively. This flux performance, however, deviated with increasing free chlorine exposure, with the standard membrane displaying an exponential increase up to four times its initial value. Such an occurrence is associated with the disruption of the PA network as a result of free chlorine interaction, where initial disruption of the network structure nearest the feedwater side lessens the diffusion distance the water must travel before exiting the membrane on the permeate side. This disruption continues deeper into the membrane, continuing to decrease the diffusion distance until a critical flaw is reached, inciting rapid flux increase and rejection decline. Conversely, the DMDAP membrane showed a decline in flux after the initial 1,000 and 3,000 ppm*h doses to 24.3 and 22.9 L/(m²h), respectively. After 10,000 ppm*h exposure, flux was 24.0 L/(m²h), resulting in a flux loss of 2.65×10−4±3.46×10−4 L/(m² ppm*h²). It is currently unknown whether the small rate of flux performance loss is a real result or an artifact due to differences of operating conditions (variations in water temperature, crossflow rate, etc.). Cyclical mass uptake and mass loss shown through free chlorine introduction and subsequent DI rinsing was attributed to mass changes associated with reversible chlorination. Lacking the aromatic ring necessary for irreversible ring chlorination, continued chlorine exposure appears to have a limited effect on the long-term performance. While the DMDAP membrane in its current form shows significant chlorine tolerance, incremental improvements in rejection may be made to meet the performance of current RO membrane technology, which commonly display rejection performances of 99+%. Also, significant improvements of flux performance to 35-60 L/(m²h) may need to be achieved. Facile surface modification using halogenated anilines, which resulted in a near tripling in flux performance of standard RO membranes could be employed, and has potential to promote such flux increase.

Results showed that these pre-halogenated structures served as a passivation layer capable of slowing chlorine uptake in the underlying PA membrane. Advantageously, the separation membrane having a DMDAP chemistry lacking N-adjacent aromatics was observed to show no evidence of irreversible chlorine uptake. A crossflow characterization of the DMDAP membrane showed no rejection performance decline and negligible flux loss, suggesting the synthesis of a chlorine proof polyamide membrane; the synthesis of which can be immediately deployed in current RO membrane manufacturing facilities.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A separations membrane comprising:
a substrate;
a microporous layer disposed on the substrate; and
a selective layer disposed on the microporous layer, thereby sandwiching the microporous layer between the selective layer and the substrate;
wherein the microporous layer includes a thermoplastic material, and
wherein the selective layer includes a diamine characterized by without having an aromatic ring structure and a chloride containing substance.

2. The separations membrane of claim 1, wherein the diamine characterized by without having an aromatic ring structure, has a polyamide structure of 2,2-Dimethyl-1,3-propanediamine.

3. The separations membrane of claim 2, wherein the chloride containing material includes 1,3,5-Benzenetricarbonyl chloride.

4. The separations membrane of claim 2, wherein the chloride containing material includes trimesoyl chloride.

5. The separations membrane of claim 1, wherein the substrate includes a non-woven polyester material.

6. The separations membrane of claim 1, wherein the thermoplastic material includes polysulfone.

7. The separations membrane of claim 1, wherein the thermoplastic material is nanoporous.

8. The separations membrane of claim 1, wherein the selective layer has a thickness of around ten nanometers or less.

9. A method of making a separations membrane, wherein the method comprises:
synthesizing a microporous layer over a substrate;
synthesizing a selective layer over the microporous layer;
curing the synthesized selective layer, the synthesized microporous layer, and the substrate;
wherein the microporous layer includes a polysulfone material, and
wherein the selective layer includes a diamine characterized by without having an aromatic ring structure and a chloride containing material.

10. The method of claim 9, wherein the diamine characterized by without having an aromatic ring structure, has a polyamide structure of 2,2-Dimethyl-1,3-propanediamine.

11. The method of claim 8, wherein the step of synthesizing the selective layer over the microporous layer further includes soaking the substrate and the microporous layer in at least one of isopropyl alcohol and deionized water.

12. The method of claim 9, wherein the step of synthesizing the selective layer over the microporous layer further includes soaking the microporous layer in an aqueous solution of 2,2-Dimethyl-1,3-propanediamine, thereby depositing 2,2-Dimethyl-1,3-propanediamine into a portion of the pores of the microporous layer.

13. The method of claim 9, wherein the step of synthesizing the selective layer over the microporous layer further includes drying the substrate and microporous layer of excess 2,2-Dimethyl-1,3-propanediamine.

14. The method of claim 9, wherein the step of synthesizing the selective layer over the microporous layer further includes soaking the microporous layer deposited with the 2,2-Dimethyl-1,3-propanediamine in a solution of 1,3,5-Benzenetricarbonyl chloride and a first solvent, thereby forming the selective layer.

15. The method of claim 8, wherein the step of synthesizing the selective layer over the microporous layer includes further includes rinsing the selective layer with a second solvent.

16. The method of claim 13, wherein the first solvent includes at least one of a hexane solvent, a pentane solvent, a heptane solvent, a decane solvent, a dodecane solvent, and a nonane solvent.

17. The method of claim 13, wherein the first solvent dissolves the 2,2-Dimethyl-1,3-propanediamine and the 1,3,5-Benzenetricarbonyl chloride.

18. The method of claim 13, wherein the first solvent has a lower density than water.

19. The method of claim 14, wherein the second solvent includes at least one of a hexane solvent, a pentane solvent, a heptane solvent, a decane solvent, a dodecane solvent, and a nonane solvent.

20. The method of claim 14, wherein the second solvent dissolves the 2,2-Dimethyl-1,3-propanediamine and 1,3,5-Benzenetricarbonyl chloride.
